(19) United States
(12) Patent Application Publication
(10) Pub. No.: US 2010/0303573 A1
(43) Pub. Date: Dec. 2, 2010

(54) Latch device with variable latching resistance and method

(75) Inventor: John B. Brewster, Homewood, IL (US)

Correspondence Address: John B. Brewster, 2060 Hawthorne Road, Homewood, IL, 60430-1109, US

(73) Assignee: Holland, L.P.

(21) Appl. No.: 12/455,457

(22) Filed: Jun. 2, 2009

(51) Int. Cl. B60P 1/64

(52) U.S. Cl. 410/69

(57) ABSTRACT

A latch device releasably secures a container to a support surface. The device comprises a housing, a latch, interchangeable spring sets, and a pin. The housing comprises an upper shell and an inner coil-receiving cavity. The shell defines a latch-receiving cavity. The latch comprises an upper latch end and a coil-engaging portion. The coil-engaging portion comprises coil-aligning structure. At least one compression coil is received within the coil-receiving cavity and placed into engagement with the coil-engaging portion so as to bias the upper latch end exterior to shell via the latch-receiving cavity. The coil-aligning structure enhances axial alignment of each coil during coil compression. The pin pivotally connects the latch to the housing for enabling pivotal movement of the latch under selectively varied spring resistance for targeted applications. The coil(s) thus enable the user to vary latching forces during latching securement and release depending to the targeted loads and conditions.

### BACKGROUND OF THE INVENTION

1. Field of the Invention

The present invention relates to container securement devices and more particularly to improvements in cargo container securement devices providing automatic securement and release of a cargo container.

2. Discussion of Prior Art

Containerized lading has become immensely popular due to advantages such as labor savings resulting from decreased cargo handling. Modular or standardized containers may be shipped from point to point using a variety of different carriers including rail cars, trucks and ships. Such cargo containers are conventionally provided with corner castings including locking openings used in securing the containers to the various types of vehicles upon which they are loaded.

One type of container securement device used in the past is a container pedestal including a base portion upon which a corner of the container rests, as well as vertically extending walls within which a corner of the container is captured. A latch pivotable about a horizontal axis engages a locking opening in a vertical wall of the container for holding the container down against the base while permitting automatic entry and release of the container. One example of such a container pedestal type is disclosed in U.S. Pat. No. 4,382,734 ('734 Patent), which issued to Synowiec et al.

The '734 Patent describes a container pedestal for supporting and securing a cargo container having a catch opening on a vehicle such as a rail car. The pedestal includes a base defining a platform for supporting the container. A pivotal latch lever is biased by a spring into a latched position wherein a latching nose on the lever registers with a latch recess in the container. The latch nose is contacted by the container for pivoting the latch lever from the latched to a released position when the container is raised or lowered. The latch lever is mounted for vertical movement as well as pivotal movement, and interfacing locking surfaces are provided on the latch lever and on the pedestal base for preventing pivotal movement of the latch lever out of the latched position when the latch lever is in an upper position.

The spring biases the latch lever upwardly to maintain the locking surfaces normally in engagement so that, when the latch lever is in its upper position, the container cannot pivot the latch lever. If a container is lowered into the pedestal with the latch lever in the upper position, the container moves the latch lever downwardly to separate the locking surfaces and permit the latch lever to pivot to the released position for automatic loading of the container. A cam is selectively operable to hold the latch lever in its lower position wherein the locking surfaces are separated and the latch lever can be pivoted by upward or downward movement of a container. A line contact between the latch lever and the spring provides a uniform spring lever arm length.

Another state of the art type of securement device used to secure cargo containers is a so-called twist lock. A twist lock typically includes a base upon which the container may rest together with a shear block engageable with a locking opening in the bottom, horizontal wall of the container corner casting. A locking head is manually moved from a released position in alignment with the shear block to a locked position in which the container cannot be lifted away from the base. The head is rotated manually between the locked and the unlocked positions, and automatic entry and release of the container is not possible.

U.S. Pat. No. 4,626,155 ('155 Patent), which issued to Hlinsky et al., discloses an automatic container securement device with a spring biased, cam surfaced head. The '155 Patent further describes a device for automatically securing a cargo container to a support such as a deck of a vehicle or a second container with which the first container is to be stacked. The device includes a base having a projecting shear block received in the locking opening of the container. A head rotates between an unlocked or loading position in which the head moves through the locking opening and a locked position in which the container is secured.

Automatic entry and release are provided by a spring within the base biasing the head to the locked position but permitting movement to the unlocked position when torque is applied by engagement of the container with a cam surface on the head. Visible indication of the locked position and positive locking of the head in the locked position may be provided. For stacked containers, two aligned shear blocks and two angularly offset heads are provided and the spring may be released for manual locking of the device to one container followed by automatic locking to the second container.

A further latch device that may be used wherever the present device can be used is illustrated in U.S. Pat. No. 5,570,981 ('981 Patent), which issued to Brewster, the specification of which is incorporated herein by reference thereto. It should be noted that one of the springs in the latch device of the '981 Patent may be formed from a material in which the stiffness varies and changes with temperature more than a metal type material. Spring stiffness is directly related to the device's latching forces for securing and releasing a cargo container.

U.S. Pat. No. 6,974,164 ('164 Patent), which issued to Brewster, discloses a Latch Device for Securing Cargo Containers. The '164 Patent describes a cargo container hold down device that includes a latch and spring used in a housing defined by a base that forms a surface thereabout on which cargo container corner fittings rest in the applied relation on the container relative to the supporting structure or platform involved.

The device further includes a bottom end that interfaces with a deck or vehicle structure for retention of the hold down device so that the opposite side of the hold down device is allowed to automatically engage and disengage with a cargo container corner fitting as necessary to achieve proper handing and transport of cargo containers, the device using a latch on a pin, the pin carried in a pocket such that the latch force varies as a function of container position and movement, thereby enabling the use of single spring in a low profile deck.

It was thus shown in the '164 Patent that with a single metallic spring, the spring stiffness rate does not vary as greatly as with a second material of a second spring. The elimination of the second spring permits the engaging and releasing of cargo containers with the desired force over a greater temperature range. The reader is further directed to U.S. Pat. Nos. 7,484,918 and 7,510,358 ('918 and '358 Patents, respectively), which issued to Brewster.

The '918 and '358 Patents draw attention to the fact that cargo containers are subjected to varied environments, including greatly varying temperatures, which temperature variance affects the resilient members of cargo container securement devices whether of the latching type or of the twist-lock type. In the '918 and '358 Patents, the interchangeability of spring components is central, an elastomeric annular torsional spring being preferred in more temperate delivery zones and a metallic spiral torsional spring being preferred in delivery zones subject to more varied temperatures.

It was thus shown in the '918 and '358 Patents that a container securement device or system having interchangeability of springs is a useful development to the industry. With the foregoing as a backdrop, the present invention was conceived. It may be understood from a consideration of the prior art, for example, that the prior art does not show a latch device having adaptability depending on its environment.

Certain latches, for example, may require a relatively low magnitude start-up latch resistance, but require a relatively high magnitude securing resistance. The prior art does not appear to show a latch device able to effectively demonstrate variable latch resistance based on the displacement of a spring from its relaxed position. Accordingly, the prior art perceives a need for such a device, as described in more detail, hereinafter.

### SUMMARY OF THE INVENTION

Providing a device with one or more resilient elements having the capability to exhibit linear stiffness and/or nonlinear and/or variable stiffness provides inherent advantages over a device that provides only a single, fixed-type stiffness. It is desirable to provide low startup actuation force in a latching device to prevent stiction. Startup stiction in a latch device creates rough startup operation which results in higher than necessary impact forces to all of the items involved and is thus not desired.

However, the latch device must provide sufficient restraining force to provide the desired securement forces for the application. The securement forces are selected by considering the railcar deck weight, dynamic railcar action, and wind forces. The desired automatic engagement and release of the device should provide as high a securement force on the container as possible to provide maximum hold down but yet not be too high so as not to lift the railcar deck off of the rails or car trucks during container removal procedures.

In applications where typical ISO type containers are used and are desired to be secured to railcars with relatively light weight decks, a device with one resilient spring element is expected to be sufficient to perform as desired. A low cost, constant diameter spring with a linear stiffness rate may be selected to provide the desired securement forces.

The geometry and weight of typical ISO type containers along with typical railcar operational speeds and conditions are some of the factors that are used in the design of a railcar and its deck. Light weight decks are desirable due to their inherent reduced costs of manufacture. Therefore, the device is allowed to be tailored with a low cost, constant diameter spring with an inherent linear stiffness rate so as to provide the desired hold down forces.

On the other hand, in applications where special geometry and/or extra heavy containers are desired for use, special relatively heavy duty railcars are used with inherently heavier decks. Since the decks of these railcars are heavier, a device that provides higher restraining force would be desirable to provide the desired securement forces for the heavier weight application.

Again, the desired device would include at least one low cost resilient spring element with a single coefficient of stiffness, but because of the special geometry and/or extra heavy containers, or higher railcar operational speeds and dynamic railcar action, a single resilient spring element may not provide enough of an operational securement force range.

The present invention provides an easy solution to this noted problem by allowing one to selectively and telescopically install one or more compression coils into the latch device depending on the application thereby simultaneously maximizing effective use of space defined by the coil structures; and tailoring the force characteristics for a given securement application.

The device according to the present invention provides one or more coils to selectively provide a linear resistance or a variable resistance. The variable resistance would be selected to provide relatively low startup actuation force to prevent stiction and as the latch retracts slightly after initial movement, the latch would retract and come into contact with the second resilient spring element providing additional stiffness resulting in a higher total securement force than would be possible with only one resilient spring element.

To achieve these objections, the present invention provides a latch device that is mountable on a deck or frame of a vehicle or similar surface as desired so that the latch device can be adapted to different load conditions including a different mix of containers of different length and the like. This latch device can be used to hold a cargo container onto a vehicle deck such as a railroad car deck. The device can be adapted to hold two cargo containers together such as in the case of double stacking containers.

Typically, four latch devices are used to fasten the four corner castings or fittings of a cargo container to a vehicle deck or similar surface. The base of the housing is oriented and fastened to the vehicle deck or similar surface in such a manner as to prevent its removal from the deck or vehicle. Welding or fasteners are examples of appropriate fastening techniques. The container's four bottom corner fittings are brought into contact with the top end of the latch device, thereby sliding over or receiving a latch-receiving top portion of the housing and engaging the convex upper surface of the protruding latch. Relatively low startup forces are selectively enabled by the user by installing a first compression coil of a first length having a select resistance to displacement ratio or resistance to displacement slope.

The latch retracts into the latch-receiving top portion of the housing as the container translates toward the vehicle deck or similar support surface. As the latch retracts, it may selectively contact additional coils telescopically received by the first compression coil and successively shorter in length than the first compression coil. Additional coil displacements are effected by latch retraction and additional resistance to displacement ratios are thereby achieved. Once the latch-actuating opening of the corner casting translates past the tip of the latch at a maximized resistance to displacement ratio or slope, the latch secures the corner casting as the compressive spring element(s) are restored to a relaxed position and the first compression coil is restored to its biased starting position.

A cargo container can be removed when the bottom lip of the corner fitting or casting contacts the concave underside of the upper portion of the latch and overcomes the latch's resistance while the container is being pulled off the housing. The relatively low startup actuation forces and relatively high securement forces are again exhibited. The relatively high securement forces effectively function to secure the cargo container from unintentional removal, but are tailored or selected so as to enable intention removal of the cargo container as exemplified by offloading procedures. In other words, when appropriate force is exerted to pull the cargo container off of the deck, the devices latch mechanism that extends outwardly from the housing will automatically retract into the devices housing allowing the cargo container to be removed.

The latch device according to the present invention thus functions to secure cargo containers to a vehicle deck or similar surface and essentially comprises a housing having a container penetrating upper portion that contains or receives a latch mechanism that extends outwardly and laterally from the upper portion of the housing to engage a cargo container corner casting. The lower portion of the housing comprises a typically flat base that is tailored to interface with a vehicle deck or similar surface. One or more resilient compression coils extend between the latch mechanism and the housing to provide the linear or variable resistance required by the application.

### BRIEF DESCRIPTION OF THE DRAWINGS

FIG. 1 is an anterior elevational view of the latch device for cargo containers according to the present invention.

FIG. 2 is a side elevational view of the latch device for cargo containers according to the present invention.

FIG. 3 is a posterior elevational view of the latch device for cargo containers according to the present invention.

FIG. 4 is a top plan view of the latch device for cargo containers according to the present invention.

FIG. 5 is a bottom plan view of the latch device for cargo containers according to the present invention.

FIG. 6 is a sectional side elevational view of the housing for the latch device according to the present invention.

FIG. 7 is a side elevational view of the latch for the latch device according to the present invention.

FIG. 8 is a sectional side elevational view showing the positions of certain of the latch device's internal components just prior to the cargo container's corner fitting engaging the device according to the present invention.

FIG. 9 is a sectional side elevational view showing the positions of certain of the latch device's internal components partially retracted into the housing while the cargo container's corner fitting engages the device according to the present invention.

FIG. 10 is a sectional side elevational view showing the positions of certain of the latch device's internal components fully retracted into the devices housing just after the cargo container's corner fitting engages the device according to the present invention.

FIG. 11 is a sectional side elevational view showing the positions of certain of the latch device's internal components while the cargo container's corner fitting is engaged with the device according to the present invention.

FIG. 12 is a sectional side elevational view showing the positions of certain of the latch device's internal components just prior to the cargo container's corner fitting being removed from the device according to the present invention.

FIG. 13 is a sectional side elevational view showing the positions of certain of the latch device's internal components during partial removal of the cargo container's corner fitting from the device according to the present invention.

FIG. 14 is a sectional side elevational view showing the positions of certain of the latch device's internal components during partial removal of the cargo container's corner fitting from the device according to the present invention.

FIG. 15 is a sectional side elevational view showing the positions of certain of the latch device's internal components retracted into the devices housing just after the cargo container's corner fitting has been removed from the device according to the present invention.

FIG. 16 is an enlarged sectional side elevational view showing the positions of certain of the latch device's internal components just prior to the cargo container's corner fitting engaging with the device according to the present invention.

FIG. 17 is a dual depiction of first and second compression coils telescopically nested according to the present invention, the top depiction showing an end view of the nested coils and the bottom depiction showing a side elevational view of the nested coils with certain parts of the outer coil broken away to show the inner coil.

FIG. 18 is a dual depiction of the first compression coil otherwise depicted in FIG. 17, the top depiction showing an end view of the coil and the bottom depiction showing a side elevational view of the coil showing left-handed chirality of the coil

FIG. 19 is a dual depiction of the second compression coil otherwise depicted in FIG. 17, the top depiction showing an end view of the coil and the bottom depiction showing a side elevational view of the coil showing right-handed chirality of the coil.

FIG. 20 is an enlarged side elevational view of first and second compression coils telescopically nested according to the present invention showing opposing chirality of the inner and outer springs, the outer spring exhibiting right-handed chirality and the inner spring exhibiting left-handed chirality.

FIG. 21 is a side elevational view of first compression coil otherwise shown in FIG. 20 exhibiting right-handed chirality.

FIG. 22 is an enlarged end view of the first and second compression coils otherwise depicted in FIG. 17, the inner coil exhibiting right-handed chirality and the outer coil exhibiting left-handed chirality.

FIG. 23 is a first sequential sectional side elevational view of the housing with latch removed showing a first compression coil being inserted into or received by the housing-based coil-receiving cavity, the first compression coil comprising a coil-based coil-receiving cavity.

FIG. 24 is a second sequential sectional side elevational view of the housing with latch removed showing the first compression coil received by the housing-based coil-receiving cavity and a second compression coil being inserted into or received by the housing-based and coil-based coil-receiving cavities.

FIG. 25 is a third sequential sectional side elevational view of the housing with latch removed showing the first compression coil received by the housing-based coil-receiving cavity and the second compression coil received by both the housing-based and coil-based coil-receiving cavities.

FIG. 26 is a first sequential sectional side elevational view of the housing with latch installed showing the latch just prior to the cargo container's corner fitting engaging the device, the protrusion of the latch being received by the outer compression coil, but not yet contacting the inner compression coil.

FIG. 27 is a second sequential sectional side elevational view of the housing with latch installed showing the latch partially retracted into the housing, the protrusion of the latch being received by both the inner and outer compression coils, the protrusion beginning to contact the inner compression coil.

FIG. 28 is a third sequential sectional side elevational view of the housing with latch installed showing the latch fully retracted into the housing, the protrusion of the latch being received by both the inner and outer compression coils, the protrusion enhancing coaxial alignment of the inner and outer compression coils.

FIG. 29 is a re-presentation of the subject matter otherwise depicted in FIG. 26.

FIG. 30 is an enlarged fragmentary view of the latch protrusion-to-coil junction site otherwise depicted in FIG. 29.

FIG. 31 is an enlarged fragmentary view of the latch protrusion-to-coil junction site otherwise depicted in FIG. 30.

FIG. 32 is a re-presentation of the subject matter otherwise depicted in FIG. 27.

FIG. 33 is an enlarged fragmentary view of the latch protrusion-to-coil junction site otherwise depicted in FIG. 32.

FIG. 34 is an enlarged fragmentary view of the latch protrusion-to-coil junction site otherwise depicted in FIG. 33.

FIG. 35 is a re-presentation of the subject matter otherwise depicted in FIG. 28.

FIG. 36 is an enlarged fragmentary view of the latch protrusion-to-coil junction site otherwise depicted in FIG. 35.

FIG. 37 is an enlarged fragmentary view of the latch protrusion-to-coil junction site otherwise depicted in FIG. 36.

FIG. 38 is a graphical depiction of compressive resistance as a function of compressive displacement depicting a linear relationship therebetween.

FIG. 39 is a graphical depiction of compressive resistance as a function of compressive displacement depicting a non-linear or variably bent relationship therebetween.

FIG. 40 is a graphical depiction of compressive resistance as a function of compressive displacement depicting a non-linear or variably curved relationship therebetween.

### DETAILED DESCRIPTION OF THE PREFERRED EMBODIMENT AND METHOD

Referring now with more specificity to the drawings, the present invention provides a latch device or assembly 10 for releasably securing a cargo container (not specifically illustrated) to a support surface (as at 25). The latch device includes or comprises a housing 11, a latch member 12, a pin 13, a first compression spring 14, and two side screws as at 15 and 37. One side screw 15 or 37 is on each side of housing 11. The housing 11 comprises an upper, container-penetrating shell as at 44 and an inner, coil-receiving cavity as at 42. The shell 44 is receivable by a latch-actuating opening 46 and defines an open-face, latch-receiving cavity as at 47.

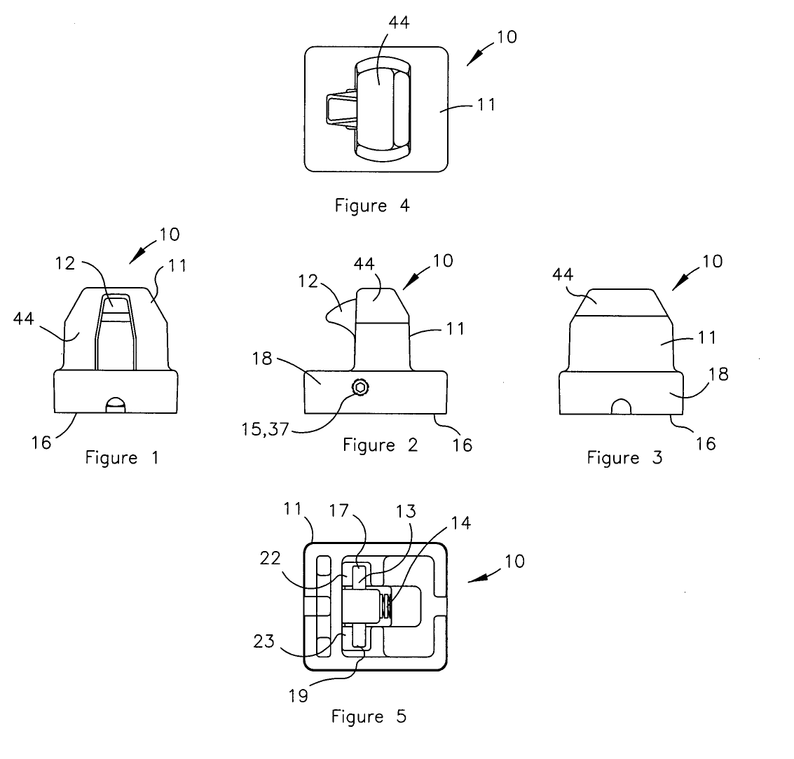

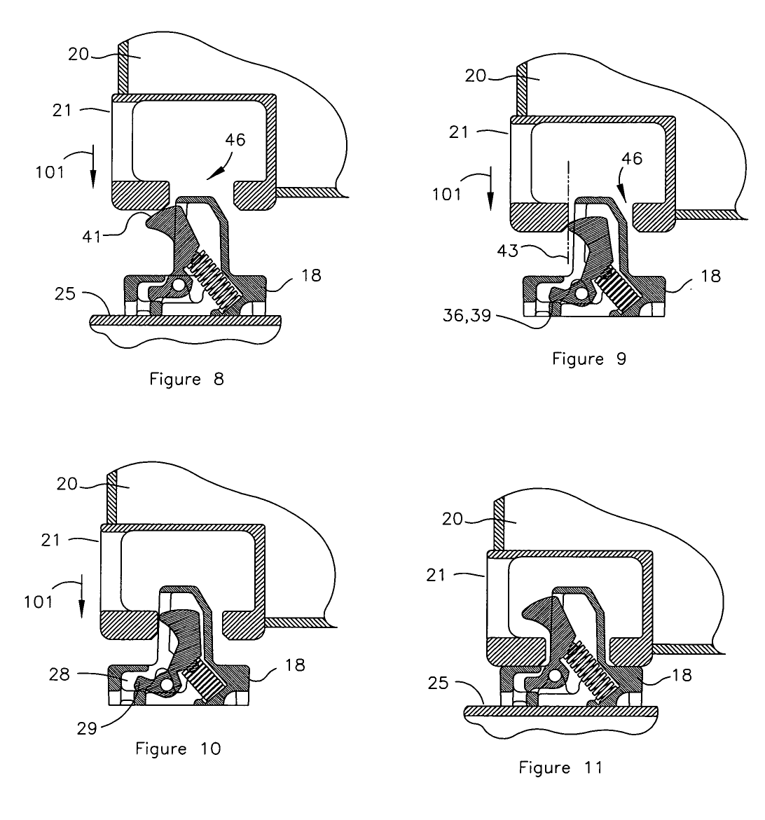

An assembled frontal view of the latch device 10 is shown in FIG. 1, and an assembled side lateral view of the latch device 10 is shown in FIG. 2. The housing 11 further comprises a base bottom 16 that interfaces with the deck or vehicle or similar planar surface as at surface 25, and a base 18 which is typically spaced between a cargo container's corner fitting 21 and a vehicle deck's appropriate structure and/or surface 25 as generally illustrated in FIG. 8.

The illustrations within this document show that the vehicle deck's appropriate structure and surface 25 is preferably flat or planar lying within a support plane. Surface 25 is preferably described herein as a vehicle deck, but may be other types of surfaces, such as a vertical support surface. In this regard, it is contemplated that the latch device 10 could conceivably be used to secure a lid to an open top container (not specifically illustrated), provided the lid were outfitted with a latch-actuating opening 46 or casting similar to that exemplified by casting 21.

Housing 11 is adapted to accommodate or receive the latch or latch member 12 via the open face cavity 47 as defined by the shell 44. Housing 11 further includes internal pockets 22 and 23 that accommodate pin 13 to secure the latch 12 inside housing 11 via the latch aperture 34. Housing 11 also includes internal pocket 28 adapted to allow latch 12 to pivot therein, and as earlier stated, the housing further includes coil-receiving cavity 42 adapted to accommodate one or more compression coils or springs (as at 14 and 48). In this last regard, it should be noted that a first or outer compression coil is illustrated and referenced at 14 and a second or inner compression coil is illustrated and referenced at 48.

The internal housing surfaces 38 and 39, respectively, are adapted to contact surface 35 and 36 of the leg 29 of latch 12 when latch 12 is in various positions. Surfaces 26 and 27 of housing 11 are adapted to accommodate pin 13 thereby allowing latch 12 to pivot in the desired positions. The latch 12 preferably comprises an upper latch end as at 49, a lower latch end as at 50, leg 29, a pivot portion as at 51, and a coil-engaging portion as at 52. It may be seen from an inspection of the figures that the coil-engaging portion 52 is preferably and structurally situated intermediate the upper latch end 49 and pivot portion 51. The upper latch end 49 preferably comprises an upper convex surface as at 41 and a lower concave surface as at 40. The pivot portion 51 has a pivot axis of rotation 100 extending coaxially with the axis of pin 13.

An important structural feature of the present invention concerns certain means for enhancing alignment of the coil(s) 14, 48, etc. as received in the housing-based, coil-receiving cavity 42. In this regard, the reader should note that the coil-engaging portion 52 preferably comprises certain coil-aligning structure, which preferably is defined by a hemispherical protrusion or rounded protrusion 30. Latch 12 thus preferably includes protrusion 30, which is preferably partially formed in the recessed, coil-engaging portion of latch 12. Protrusion 30 is adapted to accommodate or receive and/or engage the first or upper ends of coils 14, 48, etc.

In the preferred embodiment, the protrusion 30 is hemispherical as generally and perhaps most clearly depicted in FIGS. 31, 34, and 37. The hemispherical protrusion 30 has a maximum outer diameter as at 103 and a pole axis as at 104, which pole axis 104 is perpendicular to the maximum outer diameter 103 of protrusion 30. Notably, the maximum outer diameter 103 is lesser in magnitude than the inner diameter 105 of the first coil 14 and greater in magnitude than the outer diameter 106 of the second coil.

In applications involving at least two coils, the rounded terminus of protrusion 30 extends axially from the maximum outer diameter 103 toward the additional coil(s) or second coil 48 for engaging the upper end of the second coil 48 during coil compression for varying latching forces during pivotal movement of the latch or lath member 12. As is further depicted in FIG. 37, the rounded terminus of protrusion 30 is seatable in the upper end of the second coil 48 (or additional coils) for maintaining axial alignment of the second coil 48 relative to the pole axis 104.

Further, the first and second coils 14 and 48 preferably comprise opposing chirality or handedness. The opposing chirality provides crisscrossing coil structure as juxtaposed against one another, which crisscrossing structure generally prevents coil entanglement or interference with one another. In other words, the telescopically received or assembled coils tend to stay in coaxial alignment if successively nested or telescopically received coils comprise alternating opposing chirality. It is thus contemplated that the opposing chirality may further function to enhance axial alignment of the coils 14 and 48.

A latch aperture 34 is located between the leg 29 and upper surface 41 to allow pivotal movement of the latch 12. Leg 29 includes an upper housing contact surface 35 and a lower housing contact surface 36 on opposite sides. Surfaces 35 and 36 engage internal housing surfaces 38 and 39 at different times depending on the position and movement of the latch 12. The convex upper surface 41 of latch 12 opposes the concave underside 40 adapted to engage a surface of the corner casting 21 of a cargo container 20.

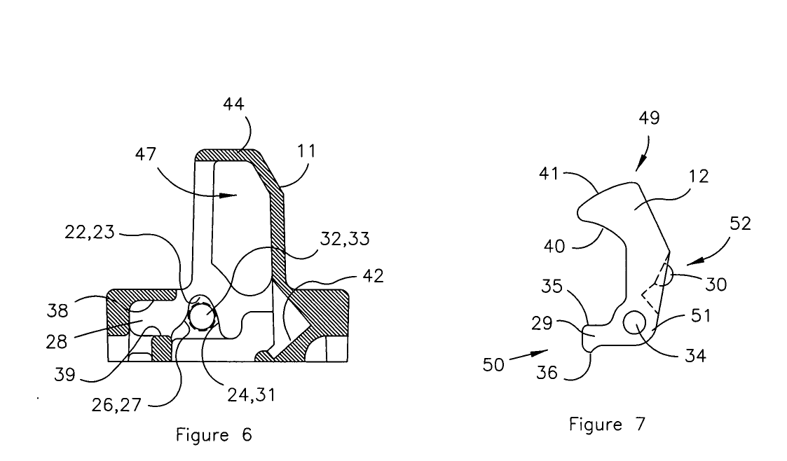

FIG. 6 illustrates side holes 32 and 33 in housing 11 that are used to insert pin 13 during the assembly of device 10. Side screws 15 and 37 are installed into side holes 32 and 33 of housing 11 to assure that pin 13 remains within housing 11 during operation of device 10. The compression coils 14, 48, etc. operate or exhibit compressive and expansive displacement between protrusion 30 of the latch 12 and cavity 42 of the housing 11. The compression coils 14, 48, etc. are structurally situated within cavity 42 in housing 11. Protrusion 30 and cavity 42 assure proper orientation or alignment and compressive action of coils 14, 48, etc. during operation of device 10.

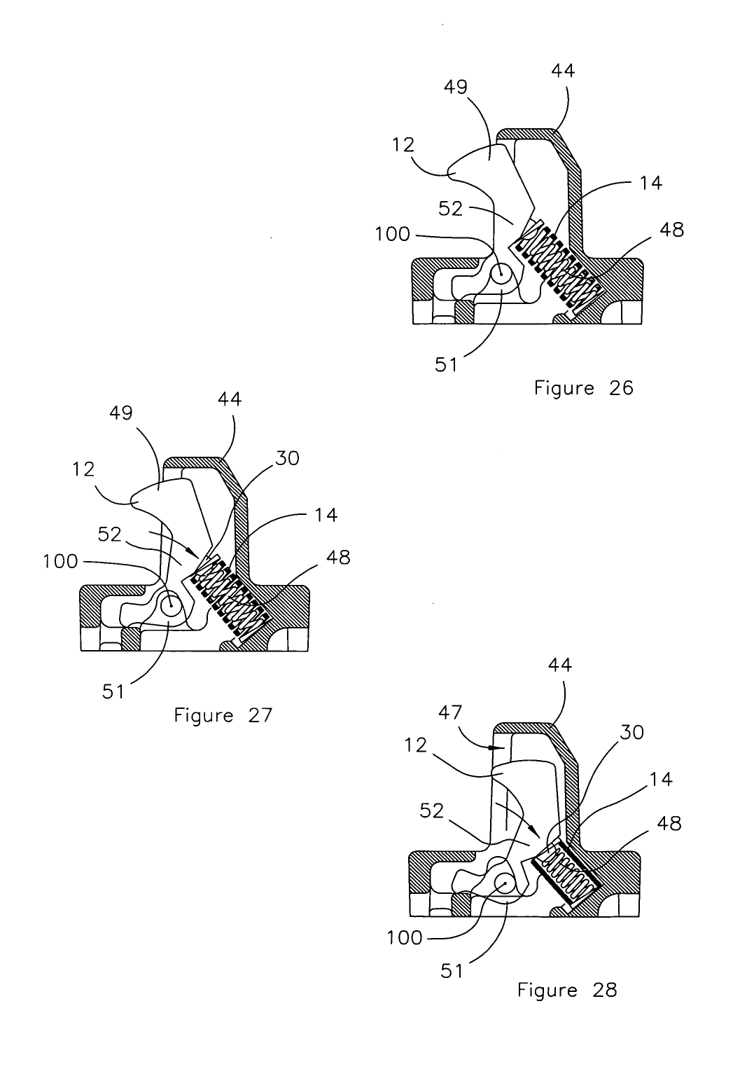

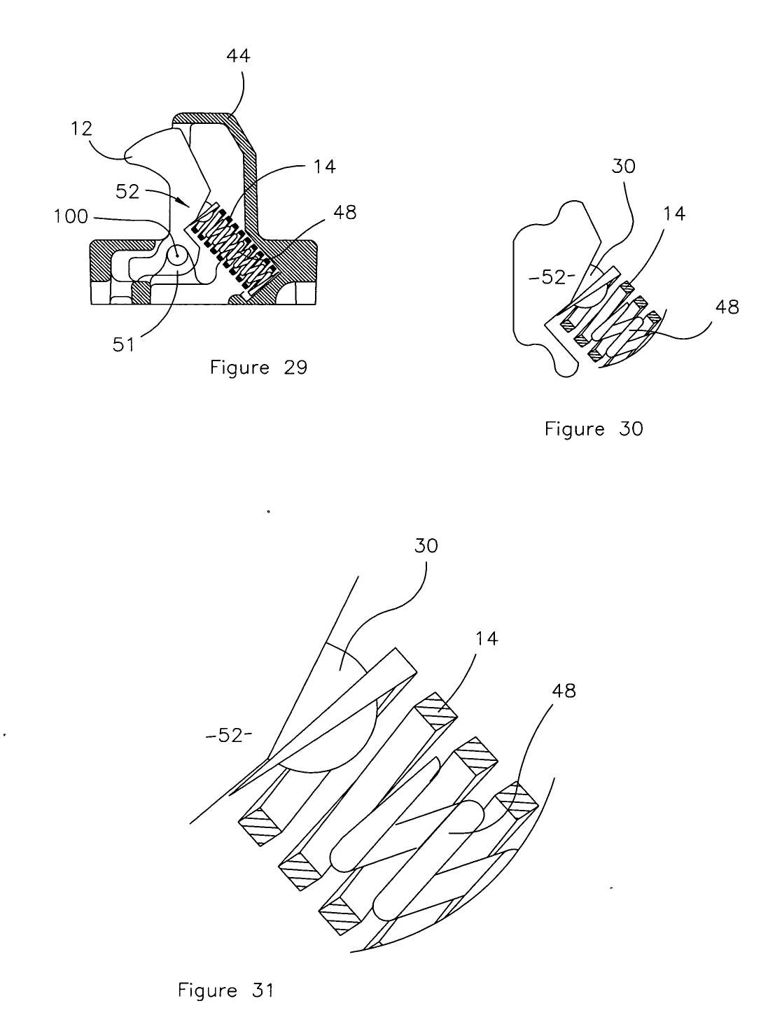

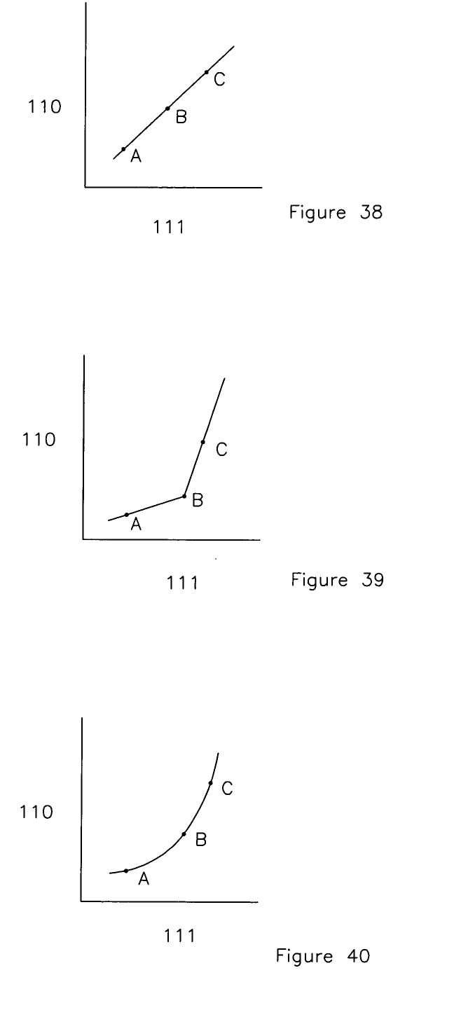

FIGS. 8, 16, 26, and 29-31 represent or depict the earliest operational stage of when a corner casting 21 of a standard cargo container 20 engages the latch device 10 for latching securement according to the present invention. The casting or container initially contacts the upper or convex surface 41 of latch 12. It should be recalled that a relatively low startup actuation (resistance) force of the first compression coil 14 is preferred at this point of contact as generally depicted at points “A” in FIGS. 38-40.

It is to be observed that latch 12 is secured in the internal pockets 22 and 23 of housing 11 by its pin 13. Latch surface 36 contacts internal housing at surface 39. Coil 14 and, if desired, coil 48 are positioned into engagement with the protrusion 30 of latch 12, which protrusion 30 assures that latch 12 is secured into proper position. As the latch-actuating opening 46 of a securable structure such as a cargo container 20 engages the latch device 10, the latch 12 pivots in the internal pocket 28 of housing 11 by its leg 29 when the securable structure such as container 20 is directed towards the surface 25. In the drawings this movement is shown as downward as at vector arrow 101.

Latch surface 36 contacts and pivots about internal housing pocket 28 at surface 39. The pin 13 is allowed to float, move, or rotate out of pockets 22 and 23 of housing 11 and translate along translation surfaces 24 and 31 of housing 11 to seek out the lowest energy position. Surfaces 24 and 31 of housing 11 are contoured to assure pin 13 and latch 12 translates and pivots through the desired motion. The actual location and shape of latch aperture 34 and surface 36 and internal pockets and housing surfaces 22, 23, 24, 31 and 39 are allowed to be tailored as desired to obtain the desired engagement action of the latch device 10.

It is to be observed that this pivot and contact area 36 of latch 12 during the engagement action of latch device 10 is akin to the prior art as demonstrated by Brewster in U.S. Pat. Nos. 5,570,981 and 6,974,164. Line of action 43 defines the travel line that the contact surfaces of corner casting 21 of a standard cargo container 20 travels while it is engaging and being placed onto the latch device 10.

Typically, it is desired that the action of latch surface 36 contacting and pivoting about internal housing pocket 28 at surface 39 be as far away and to the left of line of action 43, which results in minimizing the mechanical force advantage of coil(s) 14 (and 48) as generally depicted in FIG. 9. Minimizing the mechanical force advantage of coil(s) 14 (and 48) during the engagement motion of corner casting 21 aids in obtaining low applied forces and smooth engagement motion of latch 12. The means for pivotally connecting the pivot portion 51 to the housing 11 thus enable a moving pivot axis 100 for minimizing the mechanical force advantage of coil(s) 14 (and 48) during the engagement motion of corner casting 21, which helps obtaining lower applied forces and smoother engagement motion of latch 12.

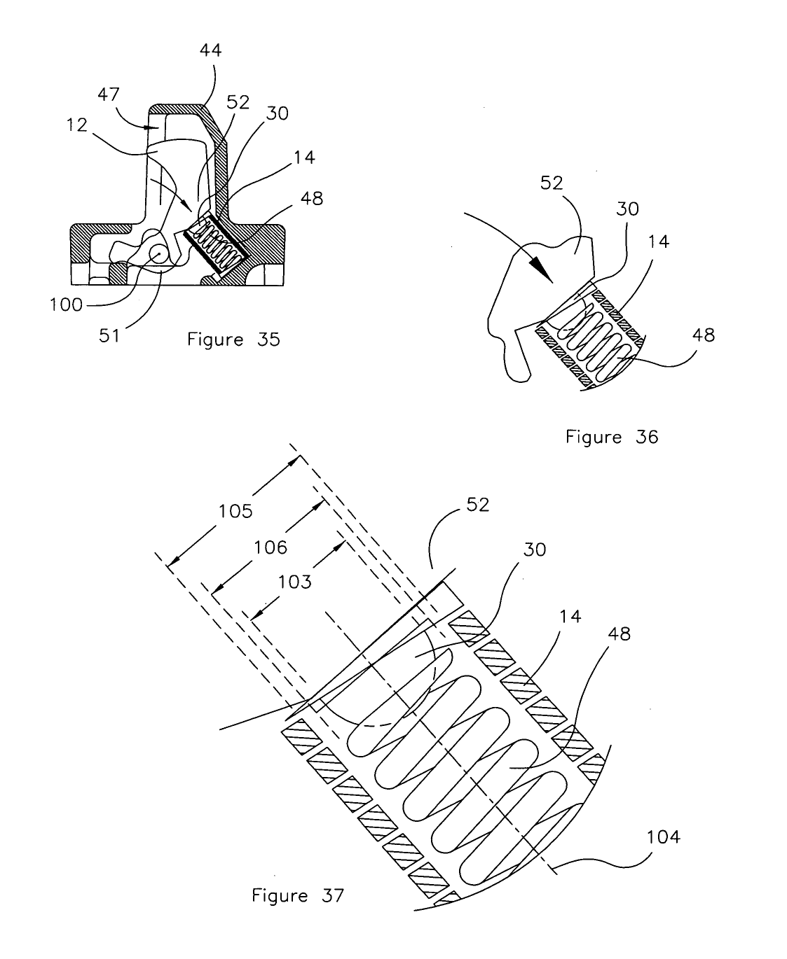

FIGS. 9, 10, 28, and 35-37 represent further operational stages such as when a corner casting 21 of a standard cargo container 20 is engaged with a latch device 10 and clears contact with the convex upper surface 41 of latch 12. At this point, a relatively high resistance is exhibited in compression coil(s) 14 (and 48) at this point of contact as generally depicted at points “C” in FIGS. 38-40.

It may again be observed that latch 12 pivots in the internal pocket 28 of housing 11 by way of leg 29. FIG. 9 shows the latch surface 36 action of contacting and pivoting about internal housing pocket 28 at surface 39. Pin 13 is allowed to rotate out of pockets 22 and 23 of housing 11 and translate along surfaces 24 and 31 of housing 11. Surfaces 24 and 31 of housing 11 are contoured to assure pin 13 and latch 12 translate and pivot through the desired motion. The actual location and shape of latch aperture 34 and surface 36 and internal housing pockets and surfaces 22, 23, 24, 31 and 39 are allowed to be tailored as desired to obtain the desired engagement action of the latch device 10.

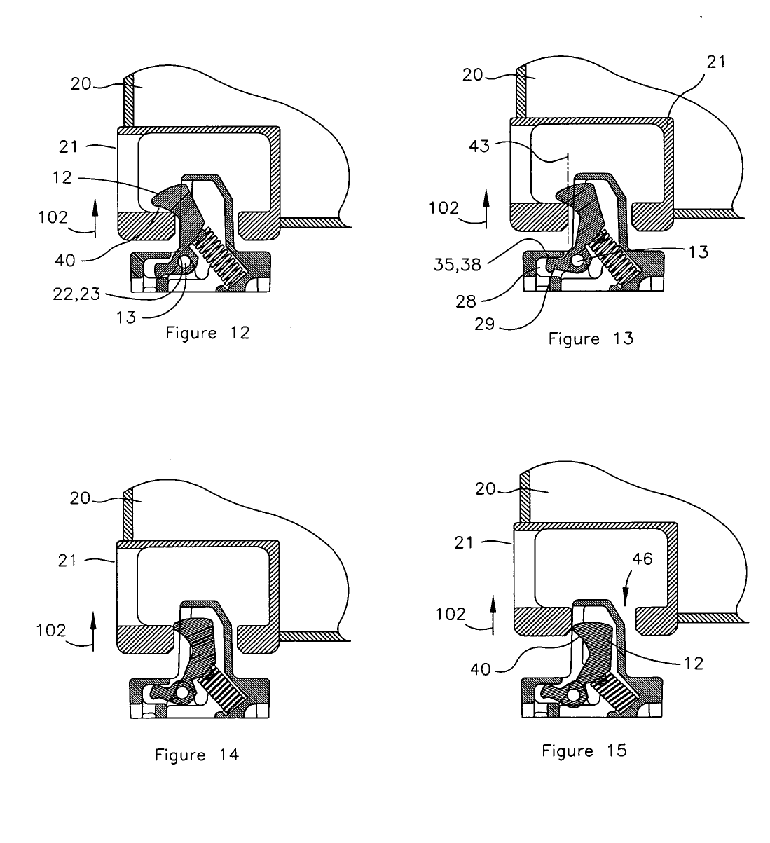

FIGS. 12, 26, and 29-31 represent or depict the earliest operational stage of when an exemplary corner casting 21 of a standard cargo container 20 is released from the latch device 10 and contacts the concave underside or surface 40 of latch 12. It should again be observed that latch 12 is secured in the internal pockets 22 and 23 of housing 11 by pin 13. The latch aperture 34 is defined by a through hole. Pin 13 interfaces with pin receiving latch aperture 34. FIG. 5 shows the two ends 17 and 19 of pin 13 extending into the internal housing pockets 22 and 23 respectively. Coil(s) 14 (and 48) are positioned onto the protrusion 30 of latch 12 thereby assuring that latch 12 is secured into proper position.

As corner casting 21 of a standard cargo container 20 comes into contact with the concave or lower surface 40 of latch 12 a relatively low startup actuation force opposes the contact. It is to be observed that latch 12 is pivoting about pin 13 in the internal pockets 22 and 23 of housing 11. Latch aperture 34 is contacting and pivoting about pin 13 in the internal housing pockets 22 and 23. Compression coil(s) 14 (and 48) are positioned onto the protrusion 30 of latch 12 thereby assuring that latch 12 translates and pivots through the desired motion. The actual location and shape of latch aperture 34 and internal housing pockets 22 and 23 may be tailored as desired to obtain the desired release action of the latch device 10.

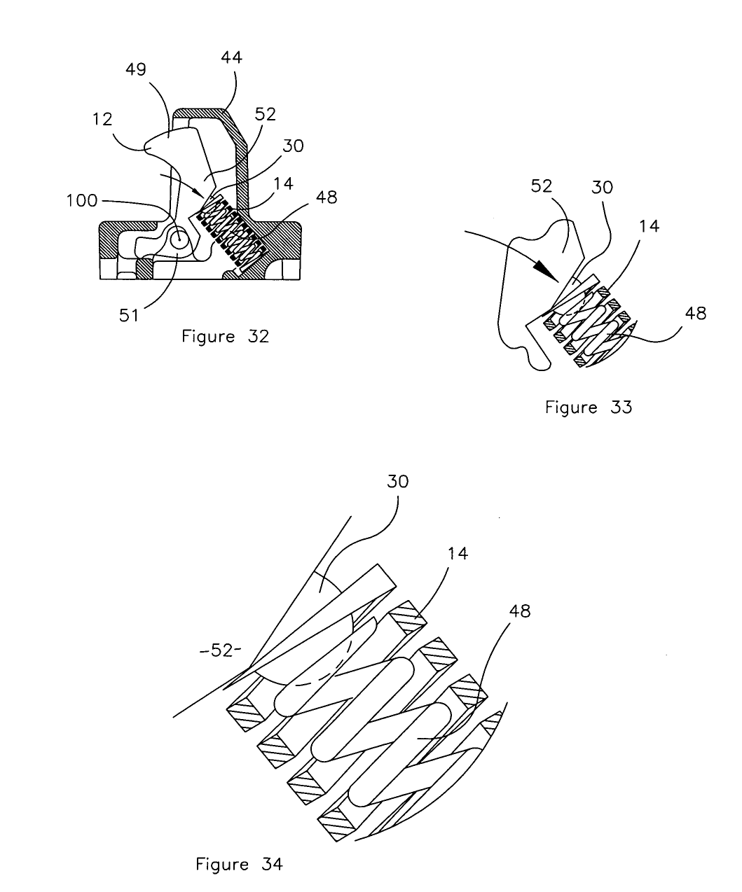

FIGS. 13, 27, and 32-34 represent the operational stage of when the latch-actuating opening 46 of a corner casting 21 of a standard cargo container 20 is contacting the concave underside or surface 40 of latch 12 and the latch may be contacting the second compression coil of a two coil installation. In a two-coil installation, a bend in the resistance to displacement function occurs at this point as generally depicted in FIG. 39 at point B as discussed in further later in this specification.

It is to be observed that leg 29 of latch 12 has pivoted and rotated in the internal pocket 28 of housing 11 about pin 13. FIG. 13 shows that surface 35 of leg 29 of latch 12 coming into contact and pivoting about internal housing pocket 28 at surface 38. Pin 13 is positioned in the internal housing pockets 22 and 23 thereby assuring that latch 12 translates and pivots through the desired motion. The actual location and shape of latch surface 35 and internal housing surface 38 may be tailored as desired to obtain the desired release action of the latch device 10.

Latch 12 of latch device 10 is guided and restrained by a pin 13 but has a latch pivot area 35 about internal housing surface 38. Line of action 43 defines the travel line that the contact surfaces of corner casting 21 of a standard cargo container 20 travels while it is being removed off of or being placed onto the latch device 10. Typically, it is desired that the latch aperture 34 action contacting and pivoting about pin 13 in internal housing pockets 22 and 23 be near or to the right of line of action 43, which again results in minimizing the mechanical force advantage of coil(s) 14 (and 48) illustrated in FIG. 13.

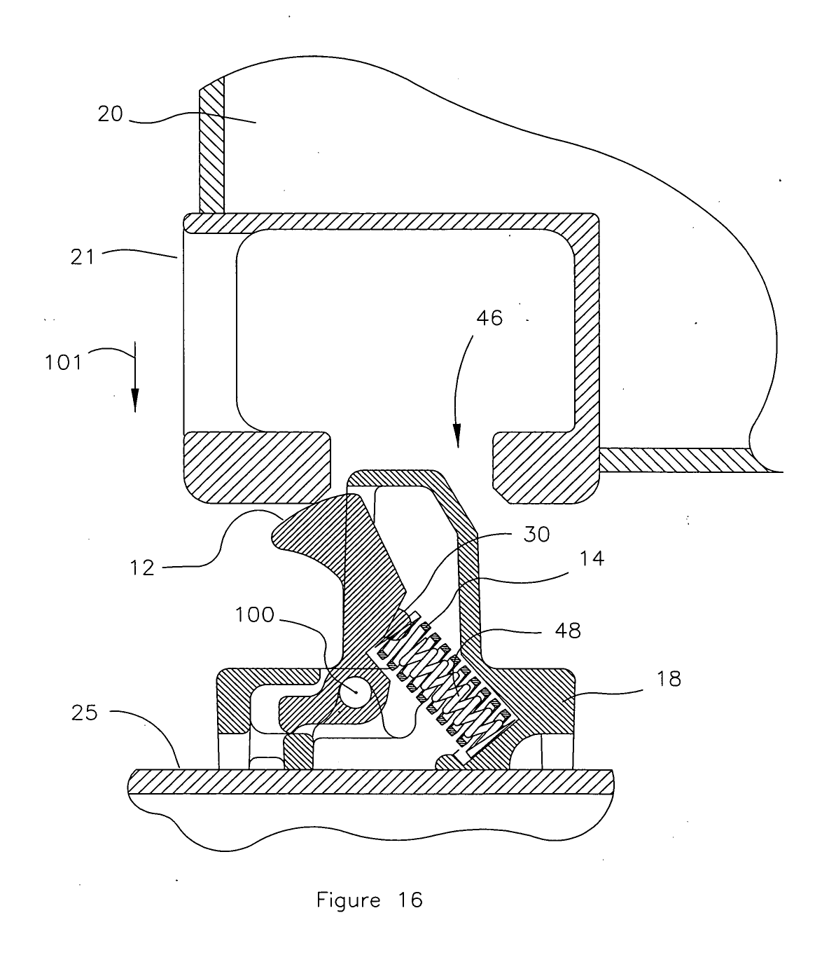

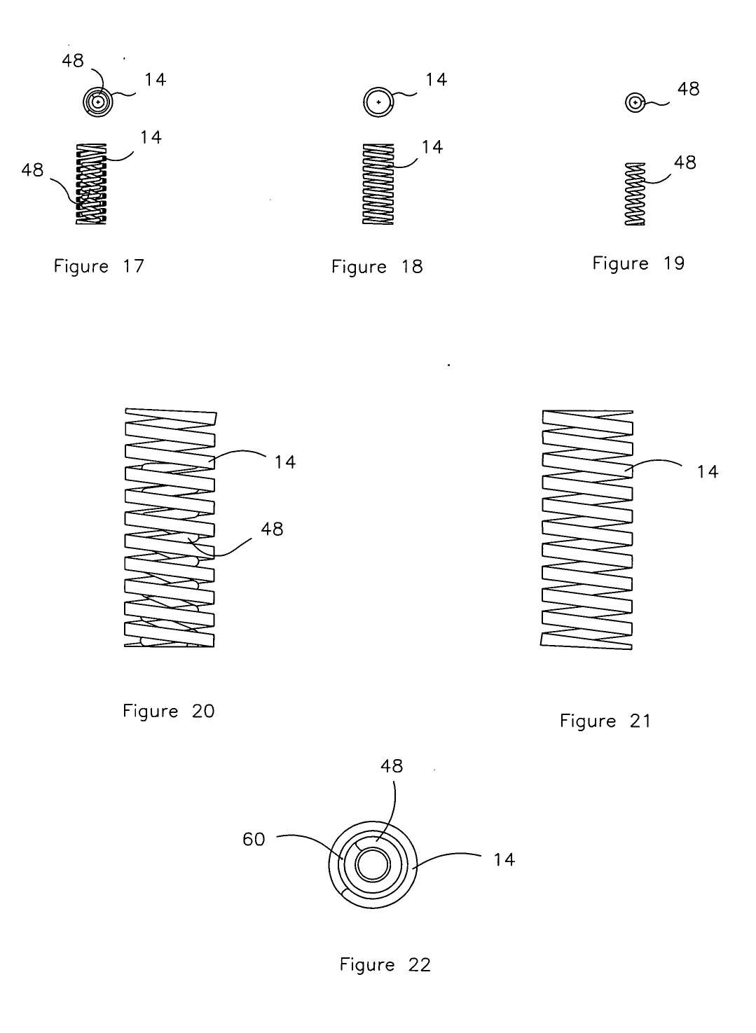

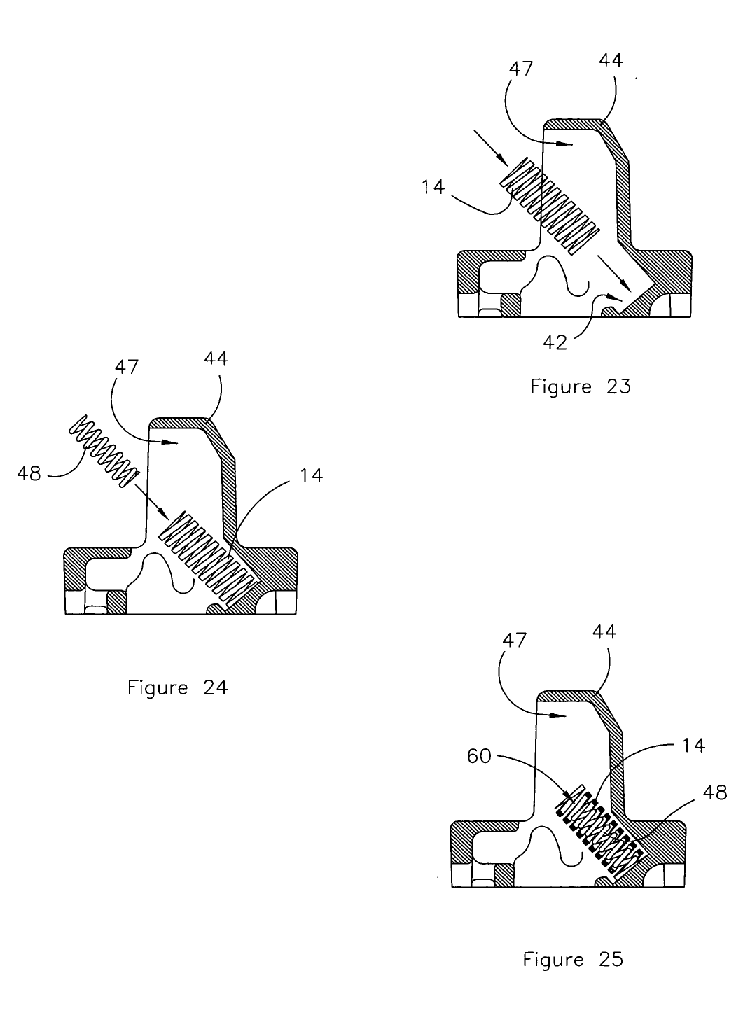

FIGS. 14, 15, 28, and 35-37 represent or depict further operational stages when a corner casting 21 of a standard cargo container 20 is released from the latch device 10, clearing contact with the concave or lower surface 40 of latch 12. It is to be observed that latch 12 pivots in the internal pocket 28 of housing 11 by way of its leg 29. FIGS. 14 and 15 show latch surface 35 contacting and pivoting about internal housing pocket 28 at surface 38. It is allowed for latch surface 35 to be contoured and to contact and pivot about internal housing pocket 28 at surface 38 to obtain the desired release effect of latch device 10.

Pin 13 is allowed to rotate out of pockets 22 and 23 of housing 11 and translate along surfaces 26 and 27 of housing 11. Surfaces 26 and 27 of housing 11 are contoured to assure pin 13 and latch 12 translates and pivots through the desired motion. The actual location and shape of latch aperture 34 and surface 35 and internal housing pockets and surfaces 22, 23, 26, 27 and 38 may be tailored as desired to obtain the desired release action of the latch device 10.

It will thus be seen that the present invention provides a latch device 10 having interchangeable resilient elements or compression coils 14, 48, etc. that have the capability to selectively exhibit linear stiffness and/or nonlinear and/or variable stiffness thereby further providing inherent advantages over a latch device that is limited to a single, fixed-type stiffness. In all cases, it should be remembered that it is desirable to incorporate a latch device exhibiting low startup actuation force to prevent stiction.

It will be recalled that startup stiction in a latch device otherwise creates rough startup operation which results in higher than necessary impact forces to all of the items involved and is not desired. In addition to the ability to provide relatively low startup actuation forces, the latch device must provide sufficient restraining force to provide the desired securement forces for the application.

The securement forces are typically selected by considering the railcar deck weight, dynamic railcar action and wind forces. The desired automatic engagement and release device is to provide as high a securement force on the container as possible to provide maximum hold down but yet not be too high so as not to lift the railcar deck off of the rails or car trucks during container removal procedures.

In applications where typical ISO type containers are used and are desired to be secured to railcars with relatively light weight decks, a device with one resilient spring element is expected to be sufficient to perform as desired. A low cost, constant diameter spring or compression coil with a linear stiffness rate may be selected to provide the desired relatively low startup actuation forces and relatively high load securement forces.

The geometry and weight of typical ISO type containers along with typical railcar operational speeds and conditions are some of the factors that are used in the design of a railcar and its deck. Light weight des are desirable due to their inherent reduced costs of manufacture. Therefore, the latch device is allowed to be tailored with a low cost, constant diameter spring with an inherent linear stiffness rate so as to provide the desired hold down forces.

In applications where special geometry and/or extra heavy containers are desired for use, special relatively heavy duty railcars are used with inherently heavier decks. Since the decks of these railcars are heavier, a latch device that provides higher restraining force would be desirable to provide the desired securement forces for the heavier weight application.

Again, the desired latch device could conceivably include one low cost, linear stiffness and resilient spring element. However, because of the special geometry and/or extra heavy containers, or higher railcar operational speeds and dynamic railcar action, one low cost, linear stiffness and resilient spring element may not provide enough of an operational securement force range.

The present invention provides an easy solution to this problem by allowing one to selectively and telescopically install one or more compression coils (such as coils 14 and 48) into the latch device 10, thereby simultaneously maximizing effective use of structural space inherently defined by coil structure(s) and tailoring force characteristics for a given securement application.

The device 10 according to the present invention provides one or more coils (such as coils 14 and 48) to selectively provide linear resistance or variable resistance. The variable resistance would be selected to provide relatively low startup actuation force to prevent stiction and as the latch retracts slightly after initial movement, the latch would retract and come into contact with the second or additional resilient spring elements providing additional stiffness resulting in a higher total securement force than would be possible with only one resilient spring element.

Thus, it will be seen that in a one coil installation as generally depicted in FIGS. 8-15, the coil resistance (as at 110 on the Y-axis) as a function of coil displacement (as at 111 on the X-axis) is substantially linear as generally depicted in FIG. 38. The coil resistance or force “F” is related to the coil stiffness coefficient “k” and the amount of coil displacement “X.” Given a first compression coil, the coil stiffness coefficient may be given by k₁, and the coil displacement may be given by X₁. The relationship may thus be written:

F=(k₁X₁), or

k₁=F÷X₁.

It will thus be seen that the stiffness coefficient of the first compression coil “k₁” is the slope of the line or ratio of resistance to displacement in FIG. 38.

In a two coil installation, the coil resistance 110 as a function of coil displacement 111 for the first compression coil 14 (of greater axial length than compression coil 48) is substantially linear as generally depicted at the line segment extending intermediate points A and B in FIG. 39.

Again, the coil resistance or force “F” is related to the coil stiffness coefficient “k” and the amount of coil displacement “X.” Given latch contact with the first compression coil 14 only as generally depicted in FIGS. 16, 26, 29-31, the coil stiffness coefficient may be given by k₁, and the coil displacement may be given by X₁. As before, the relationship may thus be written:

F=(k₁X₁), or

k₁=F÷X₁.

It will again be seen that the stiffness coefficient of the first compression coil “k₁” is the slope of the line segment intermediate points A and B or ratio of resistance to displacement along that line segment in FIG. 39. When the latch 12 makes contact with the second compression coil 48 (with a stiffness coefficient of k₂ or coil displacement of X₂) as generally depicted in FIGS. 27, and 30-32, the resulting relation may be written, as follows:

F=(k₁X₁)+(k₂X₂)

The ratio of resistance to displacement along the line segment from points B to C in FIG. 39 is thus of a second slope (preferably) greater in magnitude than the first slope extending intermediate points A and B. The line segment intermediate points B and C thus represents a combined stiffness slope and is indicative of a relatively high securing force as compared to the relatively low startup actuation force generally represented intermediate points A and B.

Conceivably, a coil of sufficient diameter and length could receive successively smaller diameter coils with successively shorter lengths, and the total resistance would thus be the summation of the products of coil stiffnesses (k₁ through kₙ) and coil displacements (X₁ through Xₙ). A smooth curve could conceivably be graphed for the resulting coil resistance and a function of coil displacement. This relationship is generally depicted in FIG. 40. An alternative relation for effecting a nonlinear variable resistance function may be written, as follows:

F=(k₁ⁿX₁)

It is thus contemplated that either a tapered or frustoconical coil (not specifically illustrated) or more than two coils could provide this desired effect.

While the foregoing specifications set forth much specificity, it should be noted that the scope of the invention should not be limited thereby. For example, while the preferred support surface 25 is flat or planar, is should be noted that the scope of the design of latch device 10 is not to be limited to a flat or planar support surface 25. Housing 11, base bottom 16 and base 18 are allowed to be varied as defined by the user.

More generally, it is contemplated that the present invention essentially provides latch device for releasably securing a cargo container, which cargo container has a latch-actuating opening. The latch device essentially comprises a housing, a latch member, at least one, but conceivably a plurality of compression coils, and certain means for pivotally connecting the latch member to the housing.

The housing essentially comprises an upper, container-penetrating shell and an inner, coil-receiving cavity. The upper, container-penetrating shell is receivable by the latch-actuating opening of the cargo container and defines an open-face, latch-receiving cavity. The latch member comprises an upper latch end, a pivot portion, and a coil-engaging portion intermediate the upper latch end and pivot portion. The upper latch end comprises an upper convex surface and a lower concave surface.

The pivot portion has a pivot axis of rotation, and the coil-engaging portion of the latch member comprises certain means for aligning the coil or certain coil-aligning structure. At least one, but selectively more than one compression coil, is received within the coil-receiving cavity. The first coil is placed into engagement with the coil-engaging portion so as to bias the upper latch end exterior to shell via the open-face, latch-receiving cavity (i.e. the locked or secured latch position). The coil-aligning structure or rounded protrusion effectively functions to maintain or enhance the axial alignment of the coil(s) during coil compression.

The means for pivotally connecting the pivot portion to the housing enables pivotal movement of the latch with respect to the housing under latch actuation from the translating latch-actuating opening of the cargo container. The convex surface engages a cargo container directed into securing engagement and the concave surface engages the cargo container directed into releasing engagement. The coil compression of the compression coil(s) varies latching forces during pivotal movement of the latch, and the shell receives the upper latch end during latching securement and release.

Should a more pronounced and varied resistance be desired, at least two compression coils may be received within the housing-based, coil-receiving cavity. A first of the coils is placed into engagement with the coil-engaging portion so as to bias the upper latch end exterior to the shell, and a second of the coils may be telescopically received within the first of the coils in a coil-based coil-receiving cavity for varying the latch forces during pivotal movement of the latch.

The second of the coils is telescopically received within the first of the coils such that the upper end of the second coil is axially and downwardly spaced from the upper end of the first coil. The coil compression during latching securement and release thereby effects a variably bent or more pronounced shift in resistance as a function of coil displacement. The variably bent resistance provides a relatively low start-up actuation force and relatively high load securement force.

In addition to the article of manufacture considerations set forth above for the latch device 10, it is contemplated that the foregoing specifications are believed to further support certain latching methodology as applied to cargo containers. In this regard, the latching method according to the present invention may be said to comprise a series of steps, including an initial step of outfitting a latch device as at 10 with a first compression coil as at 14 and a latch as at 12, which first compression coil 14 comprises a coil-receiving cavity as at 60. The first compression coil 14 further biases the latch 12 to a secured latch position as generally depicted in FIGS. 2, 4, 8, 12, 16, 26, and 29.

A latch support structure (such as a vehicle deck or platform surface 25) may then be outfitted with the latch device 10. The latch support structure or surface 25 preferably lies in a support plane. A securable structure such as a cargo container 20 may then be orthogonally directed toward the support plane or surface. The latch 12 is engaged by the securable structure to begin the process of structural securement.

The first compression coil 14 is compressed by way of this latch engagement and a relatively low startup actuation or resistance force is initially exhibited. The compressive latching action is thus linearly resisted by way of the first compression coil 14. The linear resistance exhibits a first slope or resistance-to-displacement ratio. The latch may then be disengaged from the securable structure thereby securing the securable structure by way of restoring the first compression coil 14 to its original latch-securing position.

To release the otherwise secured securable structure, the securable structure is orthogonally directed away from the support plane as for example during standard container removal procedures. The latch device is thus engaged by the securable structure for structural release. Again, the first compression coil 14 is compressed by way of the latch engagement and linearly resists the compressive latching action with a releasing slope or resistance-to-displacement ratio substantially equal to the securing slope or resistance to displacement ratio. The latch is then disengaged from the securable structure thereby releasing the securable structure and restoring the first compression coil and the latch to its original or latch-securing position.

The first compressive coil may be selectively outfitted with at least one additional compressive coil, wherein each additional compressive coil is received in the coil-based, coil-receiving cavity. The method may then be said to comprise the further steps of: variably resisting the compressive latching action by way of the first and additional compression coils, which varied resistance exhibits the first slope or resistance-to-displacement ratio, and at least one additional slope or resistance-to-displacement ratio depending on the number of additional coils.

For example, it is contemplated that the latching method may call for outfitted the first compression coil with a second compression coil, which second compression coil is received in the coil-based, coil-receiving cavity 60. In this case, the method may be said to comprise the further step of non-linearly or variably resisting the compressive latching action by way of the first and second compression coils, which the non-linear or variable resistance exhibits first and second slopes.

It will be further recalled that the latch is preferably outfitted with certain means for enhancing coil alignment, which means may be preferably defined by rounded protrusion 30. The method may thus be said to comprising the further-step of enhancing coil alignment by way of said means during coil compression. The rounded protrusion is centrally received by a first end of the first compression coil 14 and optionally the first end of the second coil 48 (or additional coils) thereby enhancing coil alignment during coil compression.

Although the preferred embodiment of the invention is illustrated and described in connection with a particular type of latch device, it can be adapted for use with a variety of latches. Other embodiments and equivalent latch devices and methods are envisioned within the scope of the invention. Various features of the invention have been particularly shown and described in connection with the illustrated embodiment of the invention; however, it must be understood that these particular embodiments merely illustrate and that the invention is to be given its fullest interpretation within the terms of the appended claims.

I claim:

1. A latch device for releasably securing a cargo container, the cargo container having a latch-actuating opening, the latch device comprising:
a housing, the housing comprising an upper, container-penetrating shell and an inner, coil-receiving cavity, the shell being receivable by the latch-actuating opening and defining an open-face, latch-receiving cavity;
a latch, the latch comprising an upper latch end, a pivot portion, and a coil-engaging portion intermediate the upper latch end and pivot portion, the upper latch end comprising an upper convex surface and a lower concave surface, the pivot portion having a pivot axis of rotation, the coil-engaging portion comprising coil-aligning structure;
at least one compression coil received within the coil-receiving cavity and placed into engagement with the coil-engaging portion so as to bias the upper latch end exterior to shell via the open-face, latch-receiving cavity, the coil-aligning structure for maintaining axial alignment of each coil during coil compression; and
means for pivotally connecting the pivot portion to the housing for enabling pivotal movement of the latch with respect to the housing, the convex surface for engaging a cargo container directed into securing engagement and the concave surface for engaging the cargo container directed into releasing engagement, each coil for varying latching forces during latching securement and release and the shell for receiving the upper latch end during latching securement and release.

2. The latch device of claim 1 wherein the coil-aligning structure is defined by a protrusion, the protrusion being received by each coil for enhancing axial alignment of each coil during coil compression.

3. The latch device of claim 2 wherein one or more compression coils are received within the coil-receiving cavity, a first of the coils being placed into engagement with the coil-engaging portion so as to bias the upper latch end exterior to the shell, a second of the coils being telescopically received within the first of the coils for varying the latching forces during latching securement and release.

4. The latch device of claim 3 wherein a second of the coils is telescopically received within a first of the coils such that the upper end of the second coil is axially spaced from the upper end of the first coil, the coil compression during latching securement and release thereby effecting variably bent resistance as a function of coil displacement, the variably bent resistance for providing relatively low start-up actuation force and relatively high load securement force.

5. The latch device of claim 4 wherein the protrusion comprises a rounded terminus, the rounded terminus being receivable by the upper ends of the coils for enhancing axial alignment of the coils during coil compression.

6. The latch device of claim 5 wherein the coils comprise opposite chirality, the opposing chirality for enhancing axial alignment of the coils.

7. The latch device of claim 6 wherein the protrusion is hemispherical, the hemispherical protrusion having a maximum outer diameter and a pole axis perpendicular to the maximum outer diameter, the maximum outer diameter being lesser in magnitude than the inner diameter of the first coil and greater in magnitude than the outer diameter of the second coil, the rounded terminus extending axially from the maximum outer diameter toward the second coil for engaging the upper end of the second coil during coil compression for varying latching forces during latching securement and release.

8. The latch device of claim 7 wherein the rounded terminus is seatable in the upper end of the second coil for maintaining axial alignment of the second coil relative to the pole axis.

9. The latch device of claim 8 wherein the means for pivotally connecting the pivot portion to the housing enables a movable pivot axis, the movable pivot axis for minimizing the mechanical force advantage of the coils during latching securement and release.

10. A latch device for releasably securing a container, the latch device comprising:
a housing, the housing comprising an upper shell and a housing-based, coil-receiving cavity, the shell being receivable by a container and defining a latch-receiving cavity;
a latch, the latch comprising an upper latch end, a pivot portion, and a coil-engaging portion, the upper latch end comprising upper and lower surfaces, the pivot portion having a pivot axis of rotation, the coil-engaging portion comprising coil-aligning means;
a first compression coil received by the coil-receiving cavity and placed into engagement with the coil-engaging portion so as to bias the upper latch end exterior to the shell for latching securement, the coil-aligning means for enhancing axial alignment of the first compression coil during coil compression; and
means for pivotally connecting the pivot portion to the housing thereby enabling pivotal movement of the latch relative to the housing, the upper surface for engaging a cargo container directed into securing engagement and the lower surface for engaging the cargo container directed into releasing engagement, the coil for varying latching forces, and the shell for receiving the upper latch end during latching securement and release.

11. The latch device of claim 10 wherein the coil-aligning means are defined by a structural protrusion, the structural protrusion being received by the first compression coil for enhancing axial alignment of said coil during coil compression.

12. The latch device of claim 11 wherein the structural protrusion comprises a rounded terminus, the rounded terminus being receivable by the first compression coil for enhancing axial alignment of said coil during coil compression.

13. The latch device of claim 12 wherein the structural protrusion is hemispherical, the hemispherical protrusion having a maximum outer diameter and a pole axis perpendicular to the maximum outer diameter, the maximum outer diameter being lesser in magnitude than the inner diameter of the first compression coil, the rounded terminus extending axially from the maximum outer diameter for enhancing axial alignment of said coil as received in the housing-based coil-receiving cavity.

14. The latch device of claim 10 wherein the first compression coil is sized and shaped to telescopically receive a second compression coil, the first compression coil thereby defining a coil-based, coil-receiving cavity.

15. The latch device of claim 14 wherein a second compression coil is telescopically received in the coil-based, coil-receiving cavity.

16. The latch device of claim 15 wherein the second compression coil functions to provide variably bent resistance as a function of compressive coil displacement, the variably bent resistance for providing relatively low start-up actuation force and relatively high load securement force.

17. The latch device of claim 15 wherein the first and second compression coils comprise opposing chirality, the opposing chirality for enhancing axial alignment of said coils.

18. The latch device of claim 13 wherein the rounded terminus is seatable in the upper end of a second compression coil telescopically received by the first compression coil for maintaining axial alignment of the second compression coil relative to the pole axis.

19. A latching method for use with cargo containers, the latching method comprising the steps of:
outfitting a latch device with a first coil and a latch, the first coil comprising a coil-receiving cavity and biasing the latch to a secure latch position;
outfitting a latch support structure with the latch device, the latch support structure having a support surface;
directing a securable structure toward the support surface, the securable structure being directed orthogonally relative to the support surface;
engaging the latch with the securable structure for structural securement, the first coil being compressed by way of latch engagement;
linearly resisting the compressive latching action by way of the first coil, the linear resistance exhibiting a first slope;
disengaging the latch from the securable structure thereby securing the securable structure by way of restoring the first coil to said secure latch position;
directing the securable structure away from the support surface, the securable structure being directed orthogonally relative to the support surface;
engaging the latch assembly with the securable structure for structural release, the first coil being compressed by way of latch engagement;
linearly resisting the compressive latching action by way of the first coil, the linear resistance exhibiting the first slope; and
disengaging the latch from the securable structure thereby releasing the securable structure and restoring the first coil to said secure latch position.

20. The latching method of claim 19 wherein the first coil is outfitted with at least one additional coil, each additional coil being received in the coil-receiving cavity, the method comprising the further step of variably resisting the compressive latching action by way of the first and additional coils, the varied resistance exhibiting the first slope and at least one additional slope.

21. The latching method of claim 19 wherein the first coil is outfitted with a second coil, the second coil being received in the coil-receiving cavity, the method comprising the further step of variably resisting the compressive latching action by way of the first and second coils, the varied resistance exhibiting the first slope and a second slope.

22. The latching method of claim 19 wherein the latch is outfitted with means for enhancing coil alignment, the method comprising the further step of enhancing coil alignment by way of said means during coil compression.

23. The latching method of claim 20 wherein the latch is outfitted with means for enhancing coil alignment, the method comprising the further step of enhancing coaxial coil alignment by way of said means during coil compression.

24. The latching method of claim 22 wherein said means are defined by a rounded protrusion, the rounded protrusion being centrally received by a first end of the first coil thereby enhancing coil alignment during coil compression.

25. The latching method of claim 23 wherein said means are defined by a rounded protrusion, the rounded protrusion being centrally received by first ends of the first and additional coils thereby enhancing coil alignment during coil compression.
